(19) United States
(12) Patent Application Publication
(10) Pub. No.: US 2021/0108931 A1
(43) Pub. Date: Apr. 15, 2021

(54) METHOD AND APPARATUS FOR DETERMINING HYBRID TRAVEL ROUTE, DEVICE AND STORAGE MEDIUM

(71) Applicant: BEIJING BAIDU NETCOM SCIENCE TECHNOLOGY CO., LTD., Beijing (CN)

(72) Inventors: Hao LIU, Beijing (CN); Jianguo DUAN, Beijing (CN); Hui XIONG, Beijing (CN)

(21) Appl. No.: 16/880,156

(22) Filed: May 21, 2020

(30) Foreign Application Priority Data
Oct. 10, 2019 (CN) 201910958280.X

(51) Int. Cl. G01C 21/34; G01C 21/36; G01C 21/32

(52) U.S. Cl. CPC G01C 21/3423; G01C 21/32; G01C 21/362; G01C 21/3453

(57) ABSTRACT

The present disclosure discloses a method and an apparatus for determining a hybrid travel route, a device and a storage medium, which relates to the field of intelligent transportation. The specific implementation solution is: the method includes: receiving a hybrid travel route obtaining request sent by a user terminal, where the obtaining request includes: starting point information and terminal point information; obtaining, from the cache database, travel information of each road section constituting at least one hybrid travel route, which matches the starting point information and the terminal point information; determining at least one hybrid travel route and hybrid route travel information according to the travel information of each road section; determining an optimal hybrid travel route according to travel information of each hybrid travel route; and sending the optimal hybrid travel route to the user terminal.

### CROSS-REFERENCE TO RELATED APPLICATION

This application claims priority to Chinese Patent Application No. 201910958280.X, filed on Oct. 10, 2019, which is hereby incorporated by reference in its entirety.

### TECHNICAL FIELD

The present disclosure relates to the field of data processing technology, and in particular, to intelligent transportation technologies.

### BACKGROUND

With urban transportation environment becomes more and more complex, travel needs of users become more and more diverse. Single travel way has been difficult to meet the diversified travel needs of the users. Therefore, a hybrid travel way, such as walking-taxi-bus, taxi-subway-walking, will bring users a more ideal travel experience.

In the prior art, when determining a hybrid travel route, firstly, the user requests a interchange point of a hybrid travel route through a client, and then requests the route from a starting point to the interchange point and the route from the interchange point to a terminal point again.

Since a dependency between the two requests, in the prior art, there are at least two request delays when determining the hybrid travel route, which makes it less efficient to determine the hybrid travel route.

### SUMMARY

Embodiments of the present disclosure provides a method and an apparatus for determining a hybrid travel route, a device and a storage medium, which solves the technical problem that there are at least two request delays when determining the hybrid travel route in the prior art, which makes it less efficient to determine the hybrid travel route.

A first aspect of an embodiment of the present disclosure provides a method for determining a hybrid travel route, where the method is applied to a first server, the first server communicates with a cache database, the cache database pre-stores travel information of each road section constituting a hybrid travel route, and the method includes:

receiving a hybrid travel route obtaining request sent by a user terminal, where the obtaining request includes: starting point information and terminal point information; obtaining, from the cache database, travel information of each road section constituting at least one hybrid travel route, which matches the starting point information and the terminal point information; determining at least one hybrid travel route and hybrid route travel information according to the travel information of each road section; determining an optimal hybrid travel route according to travel information of each hybrid travel route; and sending the optimal hybrid travel route to the user terminal.

In the embodiment of the present disclosure, since a large amount of travel information of each road section is pre-stored in the cache database, after obtaining the hybrid travel route obtaining request of the user, the travel information of each road section can be obtained from the cache database at one time, and the optimal hybrid travel route can be determined according to travel information of each road section, thereby greatly improving the efficiency of determining the hybrid travel route.

Further, as the method described above, the obtaining, from the cache database, travel information of each road section constituting at least one hybrid travel route, which matches the starting point information and the terminal point information includes:

determining a starting point position in the starting point information and a terminal point position in the terminal point information; combining the starting point position and the terminal point position into a position pair; and obtaining, from the cache database, travel information of each road section constituting at least one hybrid travel route that matches the position pair, if it is determined that the position pair exists in the preset position pair list.

In the embodiment of the present disclosure, it is determined that whether the position pair exists in the preset position pair list by determining position information of starting point information and terminal point information, forming the position pair. If it exists in the preset position pair list, travel information of each road section matching position pair from cache database is obtained, thereby preventing the phenomenon of accessing the cache database when there is no travel information matching with each road section in cache database.

Further, as the method described above, the travel information of each road section includes: starting point road section travel information, subway interchange road section travel information and terminal road section travel information.

In the embodiment of the present disclosure, the travel information of each road section includes: starting point road section travel information, subway interchange road section travel information and terminal road section travel information, so that the obtained hybrid travel route can be applied to a hybrid travel route of walking, taxi and subway.

Further, as the method described above, the determining at least one hybrid travel route and hybrid route travel information according to the travel information of each road section includes:

splicing each starting point road section, corresponding subway interchange road section, and corresponding terminal road section in sequence to form at least one hybrid travel route; and Determining, for each hybrid travel route, an optimal travel way of the starting point road section according to a walking distance in the starting point road section travel information, determining an optimal travel way of the terminal point road section according to the walking distance in the terminal point road section travel information, combining the starting point road section travel information under the optimal travel way, the subway interchange road section travel information and the terminal road section travel information under the optimal way, so as to form travel information of the hybrid travel route.

In the embodiment of the present disclosure, when determining the travel information of each hybrid travel route, starting point road section travel information under the optimal travel way and the terminal road section travel information under the optimal travel way are selected firstly, and the starting point road section travel information under the optimal travel way, the subway interchange road section travel information and the terminal road section travel information under the optimal way to are combined to form the travel information of the hybrid travel route, which can effectively reduce the amount of travel information of at least one determined hybrid travel route, and can make the selected optimal hybrid travel route be the hybrid travel route under the optimal travel way.

Further, as the method described above, the determining an optimal hybrid travel route according to travel information of each hybrid travel route includes:

determining a corresponding travel cost value according to travel information of the each hybrid travel route; and determining an optimal hybrid travel route from the hybrid travel route according to the travel cost value.

In the embodiments of the present disclosure, the optimal hybrid travel route is determined according to the travel cost value of each hybrid travel route, which can make determined optimal hybrid travel route be a travel route with the lowest travel cost, thereby can effectively meeting travel requirements of users.

Further, as the method described above, the determining a corresponding travel cost value according to travel information of the each hybrid travel route includes:

determining corresponding multiple travel cost factor values according to the travel information of each hybrid travel route; weighting sum of the multiple travel cost factor values to obtain a weighted sum result; and determining the weighted sum result as a corresponding travel cost value.

In the embodiment of the present disclosure, the travel cost value is determined according to the multiple cost factor values and corresponding weight values, so that the determined travel cost value can more comprehensively represent user the travel cost of the user.

Further, as the method mentioned above, if the optimal travel ways of the starting point road section and the terminal point road section in the hybrid travel route are a taxi travel, the travel cost factor values include: a total travel time value, a total travel expense value, an interchange times value of subway interchange road section; and if the optimal travel way of the starting point road section and/or the terminal point road section in the hybrid travel route is a walking travel, the travel cost factor values also include: a total walking distance value.

In the embodiment of the present disclosure, the travel cost factor values include a total travel time value, a total travel expense value, an interchange times value of subway interchange road section, and can also include the total walking distance value, which can make the determined travel cost value more comprehensively represent travel cost of the user, thereby making the determined optimal hybrid travel route more accurate.

Further, the method described above also includes:

storing the position pair into the position pair list if the position pair does not exist in the preset position pair list, so as to determine, after a second server obtains the position pair, corresponding travel information of each road section according to the position pair and update it to the cache database.

In the embodiment of the present disclosure, if it is determined that the position pair does not exist in preset position pair list, it means that there is no travel information of each road section matching the position pair in the cache server, then after the position pair is updated to the preset position pair list, the travel information matching each road section are also stored in the cache database, so that the user can successfully obtain travel information matching each road section form the cache database when requesting the hybrid travel route corresponding to the position pair again.

A second aspect of the embodiment of the present disclosure provides a method for determining a hybrid travel route, where the method is applied to a second server, the second server communicates with a cache database to store travel information of each road section constituting a hybrid travel route into the cache database, and the method includes:

obtaining at least one position pair stored in a preset position pair list, where the position pair includes a starting point position and a terminal point position; determining a corresponding interchange point set according to each position pair; determining travel information of each road section constituting a corresponding hybrid travel route according to the each position pair and the corresponding interchange point set; and storing the travel information of each road section into the cache database.

Further, as the method described above, the determining a corresponding interchange point set according to each position pair includes:

determining a corresponding starting interchange point set according to a starting point position of each position pair; and determining a corresponding destination interchange point set according to a terminal point position of each position pair.

Further, as the method described above, the determining a corresponding starting interchange point set according to a starting point position of each position pair includes:

obtaining at least one starting interchange point at a distance less than a preset threshold from the starting point position; and combining the at least one starting interchange point to form the starting interchange point set.

Further, as the method described above, the determining travel information of each road section constituting a corresponding hybrid travel route according to the each position pair and the corresponding interchange point set includes:

determining each starting point road section travel information according to the starting point position and each corresponding starting interchange point; determining each subway interchange road section travel information according to each starting interchange point and each destination interchange point; and determining each terminal road section travel information according to each destination interchange point and corresponding destination position.

A third aspect of the embodiment of the present disclosure provides an apparatus for determining a hybrid travel route, where the apparatus is located in a first server, the first server communicates with a cache database, the cache database pre-stores travel information of each road section constituting a hybrid travel route, and the apparatus includes:

request receiving module, configured to receive a hybrid travel route obtaining request sent by a user terminal, where the obtaining request includes: starting point information and terminal point information; travel information obtaining module, configured to obtain, from the cache database, travel information of each road section constituting at least one hybrid travel route, which matches the starting point information and the terminal point information; route determining module, configured to determine at least one hybrid route and hybrid route travel information according to the travel information of each road section; optimal route determining module, configured to determine an optimal hybrid travel route according to travel information of each hybrid travel route; and optimal route sending module, configured to send the optimal hybrid travel route to the user terminal.

Further, as the apparatus described above, the travel information obtaining module is specifically configured to determine a starting point position in starting point information and a terminal point position in the terminal point information and combine the starting point position and the terminal point position into a position pair. If it is determined that there is a position pair in the preset position pair list, travel information of each road section constituting at least one hybrid travel route that matches the position pair from the cache database is obtained.

Further, as the apparatus described above, the travel information of each road section includes: starting point road section travel information, subway interchange road section travel information and terminal road section travel information.

Further, as the apparatus described above, the route determining module is specifically configured to splice each starting point road section, corresponding subway interchange road section, and corresponding terminal road section in sequence to form at least one hybrid travel route; determine, for each hybrid travel route, an optimal travel way of the starting point road section according to a walking distance in the starting point section travel information; determine an optimal travel way of the terminal point road section according to the walking distance in the terminal point road section travel information; and combine the starting point section travel information under the optimal travel way, the subway interchange road section travel information and the terminal point road section travel information under the optimal way, so as to form travel information of the hybrid travel route.

Further, as the apparatus described above, the optimal route determining module is specifically configured to determine a corresponding travel cost value according to travel information of the each hybrid travel route; and determine an optimal hybrid travel route from the hybrid travel route according to the travel cost value.

Further, as the apparatus described above, the optimal route determining module, when determining a corresponding travel cost value according to travel information of the each hybrid travel route, is specifically configured to determine corresponding multiple travel cost factor values according to the travel information of each hybrid travel route; weight sum of the multiple travel cost factor values to obtain a weighted summation result; and determine the weighted sum result as a corresponding travel cost value.

Further, as the apparatus described above, if the optimal travel ways of the starting point road section and the terminal point road section in the hybrid travel route are a taxi travel, the travel cost factor values include: a total travel time value, a total travel expense value, an interchange times value of subway interchange road section. If the optimal travel way of the starting point road section and/or the terminal point road section in the hybrid travel route is a walking, the travel cost factor values also include: a total walking distance value.

Further, as the apparatus described above, also including: a travel information updating module, configured to store the position pair into the position pair list if the position pair does not exist in the preset position pair list, so as to determine, after a second server obtains the position pair, corresponding travel information of each road section according to the position pair and update it to the cache database.

A fourth aspect of the embodiment of the present disclosure provides an apparatus for determining hybrid travel route, where the apparatus is located in a second server, the second server communicates with a cache database to store travel information of each road section constituting a hybrid travel route into the cache database, and the apparatus includes:

a position pair obtaining module, configured to obtain at least one position pair stored in a preset position pair list, where the position pair includes a starting point position and a terminal point position; a set determining module, configured to determine a corresponding interchange point set according to each position pair; a travel information determining module, configured to determine travel information of each road section constituting a corresponding hybrid travel route according to the each position pair and the corresponding interchange point set; and a travel information storage module, configured to store the travel information of each road section into the cache database.

Further, as the apparatus described above, the set determining module is specifically configured to determine a corresponding starting interchange point set according to a starting point position of each position pair; and determine a corresponding destination interchange point set according to a terminal position of each position pair.

Further, as the apparatus described above, the set determining module, when determining a corresponding starting interchange point set according to the starting point position of each position pair, specifically, is configured to obtain at least one starting interchange point at a distance less than a preset threshold from the starting point position; and combining the at least one starting interchange point to form the starting interchange point set.

Further, the travel information determining module is specifically configured to determine each starting point road section travel information according to the starting point position and each corresponding starting interchange point; determine each subway interchange road section travel information according to each starting interchange point and each destination interchange point; and determine each terminal road section travel information according to each destination interchange point and corresponding terminal position.

A fifth aspect of the embodiment of the present disclosure provides a first server, which includes:

at least one processor; and a memory connected with the at least one processor; where

the memory stores instructions that can be executed by the at least one processor, and the instructions, when executed by the at least one processor, enable the at least one processor to execute the method according to any one of the first aspect.

A sixth aspect of the embodiment of the present disclosure provides a non-transitory computer-readable storage medium with computer instructions stored thereon, where the computer instructions are configured to cause a computer to execute the method according to any one of the first aspect.

A seventh aspect of the embodiment of the present disclosure provides a second server which includes: at least one processor and a memory connected with the at least one processor; where

the memory stores instructions that can be executed by at least one processor, and the instructions, when executed by the at least one processor, enable the at least one processor to execute the method according to any one of the second aspect.

An eighth aspect of the embodiment of the present disclosure provides a non-transitory computer-readable storage medium with computer instructions stored thereon, where the computer instructions is configured to cause a computer to execute the method according to any one of the second aspect.

A ninth aspect of the embodiment of the present disclosure provides a computer program which includes a program code. when computer runs the computer program, the program code executes the method according to the first aspect or the second aspect.

### BRIEF DESCRIPTION OF DRAWINGS

The accompanying drawings are used to better understand the present solution, but do not constitute a limitation of the present disclosure. where

FIG. 1 is a schematic flowchart of method for determining a hybrid travel route provided in Embodiment 1 of the present disclosure;

FIG. 2 is a schematic flowchart of a method for determining a hybrid travel route provided in Embodiment 1 of the present disclosure;

FIG. 3 is a schematic flowchart of step 208 in the method for determining a hybrid travel route provided in Embodiment 2 of the present disclosure;

FIG. 4 is a schematic flowchart of a method for determining a hybrid travel route provided in Embodiment 3 of the present disclosure;

FIG. 5 is a signal flowchart of the method for determining a hybrid travel route provided in Embodiment 4 of the present disclosure;

FIG. 6 is a network architecture diagram of the method for determining a hybrid travel route provided in Embodiment 4 of the present disclosure;

FIG. 7 is a structural diagram of an apparatus for determining a hybrid travel route provided in Embodiment 5 of the present disclosure;

FIG. 8 is a structural diagram of an apparatus for determining a hybrid travel route provided in Embodiment 6 of the present disclosure;

FIG. 9 is a block diagram of a first server for achieving the method for determining a hybrid travel route of the embodiments of the present disclosure;

FIG. 10 is a block diagram of a second server for achieving the method for determining a hybrid travel route of the embodiments of the present disclosure.

### DESCRIPTION OF EMBODIMENTS

The exemplary embodiments of the present disclosure will be described below in combination with the accompanying drawings, which includes various details of the embodiments of the present disclosure to facilitate understanding, and the details should be considered as exemplary merely. Therefore, those of ordinary skilled in the art should realize that various changes and modifications may be made to the embodiments described herein without departing from the scope and spirit of the present disclosure. Similarly, for clarity and simplicity, the following description omits the description of public well-known functions and structures.

In order to understand the technical solution of the present disclosure, the terms involved in the present disclosure are explained as follows:

hybrid travel route: a hybrid travel route includes multiple road sections, and travel ways of the multiple road sections have at least two. For example, in a hybrid travel route of walking, taxi and subway, a whole hybrid travel route can be divided into three sections. A first road section refers to starting from a starting point to reach a subway station A. An optional travel way can be walking or taxi. A second road section refers to starting from the subway station A to another subway station B. A travel way is subway. A third road section refers to starting from the subway station B to a terminal point, an optional travel way is walking or taxi. The three road section are spliced together in sequence to form a whole hybrid travel route. It can be understood that the hybrid travel route can also be a hybrid travel route of walking, taxi and bus.

The embodiments of the present disclosure will be described in detail below with reference to the accompanying drawings.

### Embodiment 1

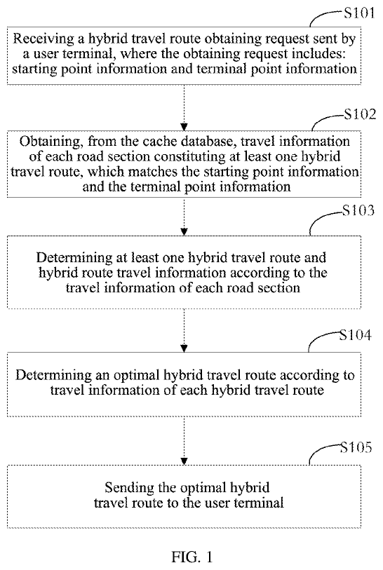

FIG. 1 is a schematic flowchart of method for determining a hybrid travel route provided in Embodiment 1 of the present disclosure, as shown in FIG. 1, an executive subject of the embodiment of the present disclosure is an apparatus for determining a hybrid travel route, and the apparatus for determining a hybrid travel route can be integrated in a first server. The method for determining a hybrid travel route provided in the embodiment includes the following several steps.

Step 101, receiving a hybrid travel route obtaining request sent by a user terminal, where the obtaining request includes: starting point information and terminal point information.

In this embodiment, when the user has a travel demand, a map client or webpage in the user terminal can be opened, and a hybrid travel route travel way is selected by setting a travel way in the map client or the webpage. And after the confirm operation is clicked a hybrid travel route obtaining request is sent to a first server, where the hybrid travel route obtaining request received by the first server includes: starting point information and terminal point information.

Where the starting point information can include: a starting point name, a starting point position and the like. similarly, the terminal point information can include: a terminal point name, a terminal point position and the like.

Where the user terminal can be a smartphone, a computer, a tablet computer and the like, which is not limited in this embodiment.

Step 102, obtaining, from the cache database, travel information of each road section constituting at least one hybrid travel route, which matches the starting point information and terminal point information.

In this embodiment, each road section of a hybrid travel route can be: a starting point road section, an interchange road section and a terminal road section. Where the starting point road section is the road section from the starting point to the starting interchange point. The interchange section is the road section from the starting interchange point to the destination interchange point. The terminal road section is the road section from the destination interchange point to the terminal point.

In this embodiment, a large amount of travel information of each road section constituting the hybrid travel route is pre-stored in the cache database.

Specifically, the starting point information and the terminal point information can be obtained from a log file of a user history request, and the starting point position in the starting point information and the terminal point position in terminal point information are obtained, so as to form a position pair constituting by the starting position and the terminal position, and the position pair is stored into the preset position pair list. The second server obtains each position pair stored in the preset position pair list, determines a corresponding interchange point set according to the each position pair; determines travel information of each road section constituting corresponding the hybrid travel route according to the each position pair and the corresponding interchange point set; and stores the travel information of each road section into the cache database. where for each road section, there may be multiple types for each road section, therefore, there may be multiple travel information for each road section.

In this embodiment, the travel information of each road section can include: a starting point position corresponding to the road section, a destination position, a travel way, travel time, a travel distance, travel expense under this travel way and the like.

In the cache database, the travel information of each road section can be stored in a key-value pair way. where the value of the “key” can store the starting position and the destination position of the road section. The value of the “Value” can store the travel way of the road section, the travel time, the travel distance, and the travel expense under this travel way and the like.

It should be understood that other ways can be also used to store travel information of each road section, which is not limited in this embodiment.

In this embodiment, since a large amount of travel information of each road section are stored in the cache database, so the travel information of each road section constituting at least one hybrid travel route, which matches the starting point information and the terminal point information can be directly obtained from the cache database.

In this embodiment, the obtaining each road section constituting at least one hybrid travel route, which matches the starting point information and the terminal point information and the travel information of the each road will be exemplarily described as follows:

A position of the starting point information is A, a position of the terminal point information is D. The starting interchange points corresponding to point A include multiple points, such as S1, S2, and S3. The destination interchange points corresponding to point D include multiple points, such as E1 and E2. Then each road section that matches the starting point information and the terminal point information obtained from cache database can include: A-S1, A-S2, and A-S3; S1-E1, S1-E2, S2-E1, S2-E2, S3-S1, and S3-E2; and E1-D and E2-D. where A-S1, A-S2, A-S3 are starting road sections, S1-E1, S1-E2, S2-E1, S2-E2, S3-E1, and S3-E2 are interchange road sections, and E1-D and E2-D are terminal road sections. Since the starting position and/or the destination position of each road section are different, the travel information corresponding to each road section that can be obtained are differently.

Step 103, determining at least one hybrid travel route and hybrid route travel information according to the travel information of each road section.

In this embodiment, since the starting interchange points and the destination interchange point of the interchange road section from the starting point to the terminal point can be multiple, there can be multiple types for each road section constituting the hybrid travel route. Each starting road section, a corresponding interchange road section and the terminal road section are spliced together to form a hybrid travel route. The travel information of the hybrid travel route can be formed by combining the travel information of the starting road section, the travel information of the corresponding interchange road section and the travel information of the terminal road section of the hybrid travel route.

Continuing the above exemplary description of step 102, the hybrid travel routes formed by splicing each starting road section, the corresponding interchange road section and the terminal road section together are respectively: A-S1-E1-D, A-S2-E1-D, A-S3-E1-D, A-S1-E2-D, A-S2-E2-D, and A-S3-E2-D.

Step 104, determining an optimal hybrid travel route according to travel information of each hybrid travel route.

In this embodiment, since the travel information of each hybrid travel route includes the travel time, the travel distance, the travel expense of each road section and the like, a hybrid travel route with a lowest travel cost can be selected according to the travel information of each road section, and the hybrid travel route with the lowest travel cost can be determined as the optimal hybrid travel route.

In step 105, sending optimal hybrid travel route to user terminal.

Specifically, in this embodiment, the optimal hybrid route and the travel information of each section of the optimal hybrid route can be sent to the user terminal, and the user can travel according to the received optimal hybrid route.

The method for determining a hybrid travel route provided in this embodiment receives a hybrid travel route obtaining request sent by a user terminal, where the obtaining request includes: starting point information and terminal point information; obtains, from the cache database, travel information of each road section constituting at least one hybrid travel route, which matches the starting point information and the terminal point information; determines at least one hybrid travel route and hybrid route travel information according to the travel information of each road section; determines an optimal hybrid travel route according to travel information of each hybrid travel route; and sends the optimal hybrid travel route to the user terminal. since a large amount of travel information of each road section are pre-stored in the cache database, after obtaining the hybrid travel route obtaining request of the user, the travel information of each road section can be obtained from the cache database at one time, and the optimal hybrid travel route can be determined according to travel information of each road section, thereby greatly improving the efficiency of determining the hybrid travel route.

### Embodiment 2

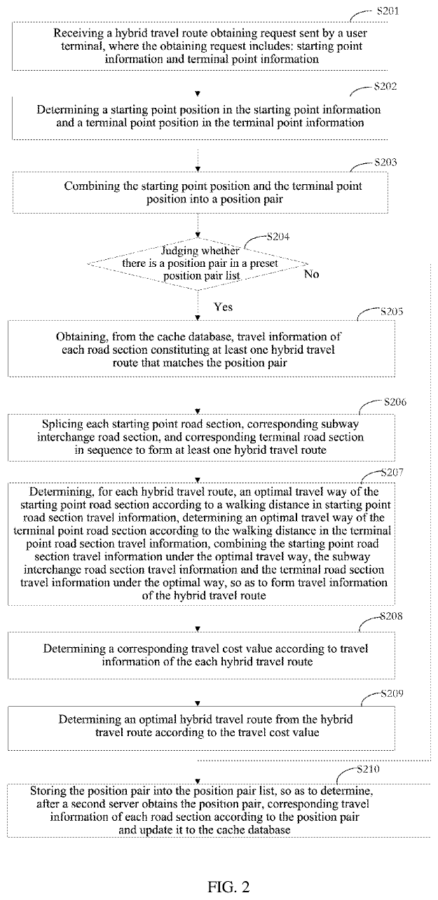

FIG. 2 is a schematic flowchart of a method for determining a hybrid travel route provided in Embodiment 1 of the present disclosure; as shown in FIG. 2, the method for determining a hybrid travel route provided in this embodiment is based on the method for determining a hybrid travel route provided in Embodiment 1 of the present disclosure and further refines steps 102-104, which also includes the step of storing the position pair into the position pair list to update cache database. The method for determining a hybrid travel route provided in this embodiment includes the following steps.

Step 201, receiving a hybrid travel route obtaining request sent by a user terminal, where the obtaining request includes: starting point information and terminal point information.

Further, in this embodiment, the obtaining request can also include obtaining time.

Step 202, determining a starting point position in the starting point information and a terminal point position in the terminal point information.

Further, in this embodiment, the starting point information includes the starting point position, the terminal point information includes the terminal point position. Coordinate representations of the starting point position and the terminal point position are obtained, and the coordinates of the starting point position and the terminal point position are gridded. After being gridded, the coordinate of the starting point position O can be expressed as (x1, y1), and the coordinate of terminal position can be expressed as D (x2, y2).

Where when the coordinates of the starting point position and the terminal point position are gridded, the coordinates within the preset range are replaced by the same coordinates.

Step 203, combining the starting point position and the terminal point position into a position pair.

Further, in this embodiment, the coordinate of the starting point position and the coordinate of the terminal point position are combined into a position pair which can be expressed as OD. The position pair has four elements, namely (x1, y1, x2, y2).

Step 204, judging whether there is a position pair in a preset position pair list; if so, executing step 205; otherwise, executing step 210.

Step 205, obtaining, from the cache database, travel information of each road section constituting at least one hybrid travel route that matches the position pair.

Further, in this embodiment, the hybrid travel route is a hybrid travel route of walking, taxi and subway. Then, the travel information of each road section includes: starting point road section travel information, subway interchange road section travel information and terminal road section travel information.

The travel information of each road section constituting at least one hybrid travel route stored in the cache database is expressed in the form of key-value pair. The starting point road section travel information, the subway interchange road section travel information and the terminal road section travel information are stored in the form of corresponding tables. The starting point road section travel information is a first table, the subway interchange road section travel information is a second table, and the terminal road section travel information is a third table.

In the first table, the “key” value stores the starting position coordinate and the destination position coordinate of the starting point road section. The starting point position coordinate of the starting point road section is the position coordinate of the starting point O, and the destination position coordinate is the position coordinate of the starting interchange point. Since the travel information of the “Value” value corresponding to different travel time period is different, the travel time period corresponding to the starting point road section can also be stored in the “key” value. The “Value” value of the first table can store walking time, a walking distance, taxi time, a taxi distance and taxi expense in the travel period. Each key-value pair in the first table together constitutes the travel information corresponding to the starting point road section.

In the second table, the “key” value stores the starting position coordinate and destination position coordinate of the subway interchange road section. The starting position coordinate of the subway interchange road section is the position coordinate of the starting interchange point, and the destination position coordinate is the position coordinate of the destination interchange point. Similarly, the corresponding travel period of the subway interchange road section can be stored in the “key” value. The “Value” value of the second table can store subway time, a subway distance, interchange times and subway expense in the travel period. Each key-value pair in the second table together constitutes the travel information of the corresponding subway interchange road section.

In the third table, the “key” value stores the starting point position coordinate and the destination position coordinate of the terminal road section. The starting point position coordinate of the terminal road section is the position coordinate of the destination interchange point, and the destination position coordinate is the position coordinate of the terminal point. Similarly, the corresponding travel time of the terminal road section can also be stored in the “key” value. The “Value” value of the third table can store walking time, a walking distance, taxi time, a taxi distance, and taxi expense in the travel period. Each key-value pair in the third table together constitutes travel information of the corresponding terminal road section.

Further, in this embodiment, the preset position pair list can be set on a storage area or stored in a storage device, the first server can obtain the preset position pair list by accessing the storage area or the storage device. The position pair list stores the position pair obtained from the log file of the user history request. The preset position pair list can be stored in the form of a file.

If the position pair corresponding to the starting point information and the terminal point information is exists in the preset position pair list, it means that the cache database stores travel information of each road section matching each other. The travel information of at least one starting point road section matching with the starting point position coordinate in the position pair is obtained from cache database. The travel information of at least one terminal point road section matching with the terminal point position coordinate in the position pair is obtained from cache database. The position coordinate of the starting interchange point and the position coordinate of the destination interchange point are obtained from each matching starting point road section travel information and each destination road section traveling information, and the travel information of at least one subway interchange road section matching the position coordinate of the starting interchange point and the position coordinate of the determining interchange point is obtained from the cache database.

optionally, in order to obtain the travel information of each road section matching with the obtained time of the received hybrid travel route obtaining request, when obtaining travel information of each road section from cache database, the obtained time and the travel period of each road section can also be matched to obtain the travel information of each road section matching with position pair in matching travel period.

It can be understood that steps 202-205 are an optional implementation of step 102 in the embodiment shown in FIG. 1.

In this embodiment, it is determined that whether the position pair exists in the preset position pair list by determining position information of starting point information and terminal point information, forming the position pair. If it exists in the preset position pair list, travel information of each road section matching position pair from cache database is obtained, thereby preventing the phenomenon of accessing the cache database when there is no travel information matching with each road section in cache database.

Step 206, splicing each starting point road section, the corresponding subway interchange road section, and corresponding terminal road section in sequence to form at least one hybrid travel route.

In this embodiment, the subway interchange road section corresponding to the starting section is obtained according to the relationship that destination position coordinate of the starting road section and the starting position coordinate of the subway interchange road section are same. Similarly, the terminal road section corresponding to the subway interchange road section is obtained according to the relationship that destination position coordinate of the subway interchange road section and the starting position coordinate of the destination road section are same. After the starting point road section and the corresponding subway interchange road section are spliced and the corresponding subway interchange road section and the corresponding terminal road section are spliced, the corresponding hybrid travel route is formed. Step 207, determining, for each hybrid travel route, an optimal travel way of THE starting point road section according to a walking distance in starting point road section travel information, determining an optimal travel way of the terminal point road section according to the walking distance in the terminal point road section travel information, combining the starting point road section travel information under the optimal travel way, the subway interchange road section travel information and the terminal road section travel information under the optimal way, so as to form travel information of the hybrid travel route.

Further, in this embodiment, since both travel ways of the travel information of the starting point road section and the terminal road section are walking travel or taxi travel, it is necessary to determine an optimal travel way of the starting point road section and the terminal road section firstly. When determining the optimal travel way of the starting point road section, a farthest walking distance can be set in advance, the walking distance of the starting point road section is compared with the farthest walking distance. If the walking distance of the starting point road section is greater than the farthest walking distance, the optimal travel way of the starting point road section is taxi. If the walking distance of the starting point road section is less than or equal to the farthest walking distance, the optimal travel way of the starting point road section is walking. Similarly, when determining the optimal travel way of the terminal road section, the walking distance of the terminal point section is compared with the farthest walking distance. If the walking distance of the terminal point road section is greater than the farthest walking distance, it is determined that the optimal travel way of the terminal point road section is taxi. If the walking distance of the terminal point road section is less than or equal to the farthest walking distance, it is determined that the optimal travel way of the terminal point road section is walking.

In this embodiment, in the starting point road section travel information under the optimal travel way, the “key” value stores the position coordinate of the starting point O, the position coordinate of the starting interchange point and the travel period. The “Value” value stores the travel time, the travel distance and the travel expense of the optimal travel way.

Similarly, in the terminal road section travel information under the optimal travel way, the “key” value stores the position coordinates of the destination interchange point, the position coordinate of the terminal point and the travel time. The “Value” value stores the travel time, the travel distance and the travel expense of the optimal travel way.

It can be understood that if the optimal travel way is walking, the travel expense in “Value” value is zero.

Therefore, in this embodiment, the starting point road section travel information under the optimal travel way, the subway interchange road section travel information and the terminal road section travel information under the optimal way are combined to form the travel information of the hybrid travel routes, including: the key-value pair of the starting point road section under the optimal travel way, the key-value pair of the subway interchange road section, and the key-value pair of the terminal section under the optimal travel way.

It is understood that steps 206-207 are an optional embodiment of step 103 in the embodiment shown in FIG. 1.

In this embodiment, when determining travel information of each hybrid travel route, starting point road section travel information under the optimal travel way are selected firstly, and the starting point road section travel information under the optimal travel way, the subway interchange road section travel information and the terminal road section travel information under the optimal way are combined to form the travel information of the hybrid travel route, which can effectively reduce the amount of travel information of at least one determined hybrid travel route, and can make the selected optimal hybrid travel route be the hybrid travel route under the optimal travel way.

Step 208, determining a corresponding travel cost value according to travel information of the each hybrid travel route.

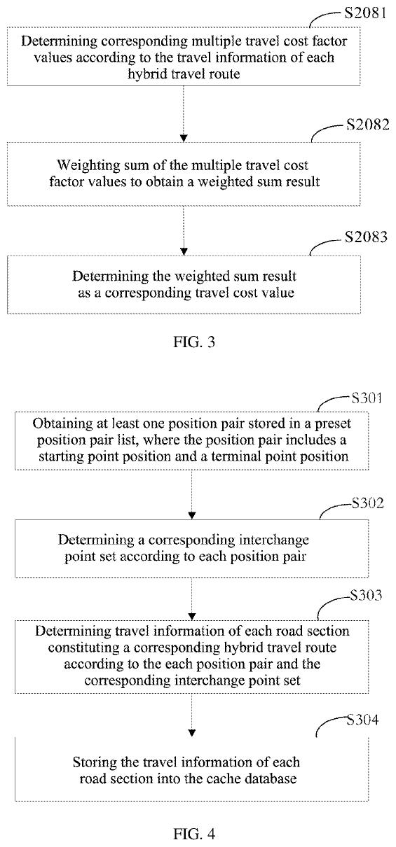

Optionally, in this embodiment, as shown in FIG. 3, step 208 includes following steps.

Step 2081, determining corresponding multiple travel cost factor values according to the travel information of each hybrid travel route.

Where, if the optimal travel ways of both starting point and terminal point section in the hybrid travel route are taxi, then the travel cost factor values include: total travel time value, a total travel expense value, section times value of a subway interchange road.

If the optimal travel way of the starting point and/or the terminal point section in the hybrid travel route is walking, the travel cost factor value also includes: a total walking distance value.

Specifically, in this embodiment, if the optimal travel way of both starting point road section and terminal point road section of the hybrid travel route is taxi, travel time and travel expense are extracted from the travel information of the starting point road section under the optimal travel way, the travel information of the subway interchange road section, the travel information of the terminal point road section under the optimal travel way, respectively. The travel time of each road section are added to obtain a total travel time. The travel expenses of each road section are added to obtain a total travel expense. The interchange times value is extracted from the travel information of the subway interchange road section. The total travel time value, the total travel expense value, and the interchange times value of the subway interchange road section are regarded as the travel cost factor value.

If the optimal travel way of the starting point road section and/or the terminal point road section of the hybrid travel route is walking, a walking distance value is also extracted from the starting point road section and/or the terminal point road section under the optimal travel way which is walking. The total walking distance value is determined from the extracted walking distance value. If the optimal travel way of both the starting point and the terminal point road section is walking, the total walking distance value is a sum of walking distance values of the starting point road section and the terminal point road section. If the optimal travel way of the starting point road section or the terminal point road section is walking, the walking distance value of the starting point road section or the terminal road section is determined as a total walking distance value. Then the travel cost factor value includes not only the total travel time value, the total travel expense value, the interchange times value of the subway interchange road section, but also the total walking distance value.

Step 2082, weighting sum of the multiple travel cost factor values to obtain a weighted sum result.

Step 2083, determining the weighted sum result as a corresponding travel cost value.

In this embodiment, each travel cost factor value is set as a corresponding weight. If the travel cost factor value includes a total travel time value, a total travel expense value, an interchange times value of the subway interchange road section, then the corresponding travel value determined can be expressed as formula (1):

cost=α·time+β·price+δ·trans_num (1)

If the travel cost factor value includes a total travel time value, a total travel expense value, an interchange times value of the subway interchange road section and a total walking distance value, then the corresponding travel cost value determined can be expressed as formula (2):

cost−α·time+β·price+γ·distance_walk+δ·trans_num (2)

where time is total travel time value, α is a weight corresponding to the total travel time value, price is a total travel expense value, β is a weight corresponding to the total travel expense value, distance_walk is a total walking distance value, γ is a corresponding weight of the total walking distance, trans_num is an interchange times value of the subway interchange road section, and δ is a weight corresponding to the interchange times value.

Step 209: determining an optimal hybrid travel route from the hybrid travel route according to the travel cost value.

Further, in this embodiment, the travel cost value corresponding to each hybrid travel route is determined, and the hybrid travel route corresponding to the minimum travel cost value is determined as an optimal hybrid travel route.

It is understood that steps 208-209 are an optional embodiment of step 104 in the embodiment shown in FIG. 1.

In this embodiment, the travel cost value is determined according to multiple cost factor values and corresponding weights, so that the determined travel cost value can more comprehensively represent the travel cost of the user, further make the determined optimal hybrid travel route more accurate.

Step 210, storing the position pair into the position pair list, so as to determine, after a second server obtains the position pair, corresponding travel information of each road section according to the position pair and update it to the cache database.

Further, in this embodiment, if there is no position pair corresponding to the starting point information and the terminal point information of the hybrid travel route obtaining request exists in the position pair list, it means that the travel information of each road section matching with position pair is not stored in cache database. Then the position pair is stored into the position pair list. After the second server obtains the position pair, the corresponding interchange point set is determined according to the position pair; and the travel information of each road section constituted the corresponding hybrid travel route is determined according to position pair and the corresponding interchange point set; and the travel information of each road section is updated into the cache database.

In this embodiment, if it is determined that the position pair does not exist in preset position pair list, it means that there is no travel information of each road section matching the position pair in the cache server, then after the position pair is updated to the preset position pair list, the travel information matching each road section are also stored in the cache database, so that the user can successfully obtain travel information matching each road section form the cache database when requesting the hybrid travel route corresponding to the position pair again.

### Embodiment 3

FIG. 4 is a schematic flowchart of a method for determining a hybrid travel route provided in Embodiment 3 of the present disclosure, as shown in FIG. 4, an executive subject of the embodiment of the present disclosure is an apparatus for determining a hybrid travel route, and the apparatus for determining a the hybrid travel route can be integrated in a second server. The method for determining a hybrid travel route provided in the embodiment includes the following several steps.

Step 301: obtaining at least one position pair stored in a preset position pair list, where the position pair includes a starting point position and a terminal point position.

In this embodiment, the preset position pair list can be set on a storage area or a storage device, and the second server can obtain the preset position pair list by accessing the storage area or the storage device. The position pair list stores position pairs obtained from the log file of the user history request, and may also store position pairs extracted from the start point information and the terminal point information in the hybrid travel route obtaining request received from the first server.

Where the starting point position and the terminal point position of the position pair can be expressed in the form of coordinates. For example, a position pair OD can be expressed as (x1, y1, x2, y2). Where (x1, y1) is a coordinate of the starting position 0, and (x2, y2) is a coordinate of the terminal position D.

Step 302, determining a corresponding interchange point set according to each position pair.

Optionally, in this embodiment, the determining a corresponding interchange point set according to each position pair includes:

determining a corresponding starting interchange point set according to a starting point position of each position pair, and determining a corresponding destination interchange point set according to the terminal position of each position pair.

As an optional implementation, when a corresponding starting interchange point set is determined according to a starting point position of each position pair, an interchange point within the preset distance range from the starting point position can be determined as a starting interchange point according to a starting point position, and a starting interchange point set consisting of each starting interchange point. When a corresponding destination interchange point set is determined according to the destination position of each position pair, the interchange point within the preset distance range with the destination position can be determined as the destination interchange point according to the destination position, and a destination interchange point set consisting of each destination interchange point.

As another optional implementation, the determining a corresponding starting interchange point set according to a starting position of each position, including:

obtaining at least one starting interchange point that is less than the preset distance threshold from the starting point position, and combining at least one starting interchange point to form a starting interchange point set.

Specifically, in this embodiment, the distance threshold is set in advance, so as to obtain the interchange points around the starting point position, and the distance between each interchange point and the starting point position is calculated. If the distance between the interchange point and the starting point position is less than the preset distance threshold, the interchange point is determined as the starting interchange point. If the distance between the interchange point and the starting point position is greater than or equal to the preset distance threshold, the interchange point cannot be used as a starting interchange point. The determined starting interchange points are combined to form a starting interchange point set.

similarly, the determining a corresponding destination interchange point set according to the terminal position of each position pair includes:

obtaining at least one destination interchange point that is less than preset distance threshold from the terminal point position, and combining at least one destination interchange point to form a destination interchange point set.

Specifically, in this embodiment, the interchange point around the destination position is obtained, the distance between each interchange point and the terminal point position is calculated. If the distance between the interchange point and the t terminal point position is less than the preset distance threshold, the interchange point is determined as the destination interchange point. If the distance between the interchange point and the terminal point position is greater than or equal to the preset distance threshold, the interchange point cannot be used as a destination interchange point. The determined destination interchange points are combined to form a destination interchange point set.

Step 303, determining travel information of each road section constituting a corresponding hybrid travel route according to the each position pair and the corresponding interchange point set.

Optionally, in this embodiment, the travel information of each road section in the hybrid travel route includes: starting point road section travel information, subway interchange road section travel information and terminal road section travel information.

Therefore, the determining travel information of each road section constituting a corresponding hybrid travel route according to the each position pair and the corresponding interchange point set includes:

Each starting point road section travel information is determined according to starting point position and each corresponding starting interchange point. Each subway interchange road section travel information is determined according to each starting interchange point and each destination interchange point. Each terminal road section travel information is determined according to each destination interchange point and the corresponding terminal position.

Specifically, in this embodiment, the way of determining travel information of each starting point section according to the position of the starting point and each corresponding starting interchange point can be: for each starting point road section travel information, the obtained request for obtaining the starting point road section travel information is sent to the third server, where starting point road section travel information includes starting point information and starting point interchange point information. The third server obtains the travel information of the corresponding starting point road section according to the starting point information and the starting interchange point information, and sends the starting point road section travel information to the second server.

Where the starting point road section travel information can include: the starting point position coordinate of the starting point road section, the position coordinate of the starting interchange point and different travel periods, as well as walking time, a walking distance, taxi time, a taxi distance, taxi expense in the different travel periods.

Similarly, in this embodiment, the way of determining each subway interchange road section travel information according to each starting interchange point and each destination interchange point is similar to the way of determining each starting road section ravel information according to the starting point position and each corresponding starting interchange point. The way of determining the each destination road section travel information according to the destination interchange point and the corresponding destination point position is similar to the way of determining each starting road section travel information according to the starting point position and each corresponding starting interchange point, which will not be described in detail here.

Where the subway interchange road section travel information can include: the position coordinate of the starting interchange point, the position coordinate of the destination interchange point, different travel periods, and subway time in different travel periods, the subway distance, the interchange times and the subway expense.

Where the terminal point riding road section travel information can include: a position coordinate of the destination interchange point, a position coordinate of the terminal point, different travel periods, and walking time, a walking distance, taxi time, a taxi distance, taxi expense in the travel period.

Step 304: storing the travel information of each road section into the cache database.

Optionally, in this embodiment, the travel information of each road section stored into cache database in the form of key-value pair. The cache database can include three tables: the first table is starting point road section travel information, the second table is subway interchange road section travel information, and the third table is terminal road section travel information.

It is worth noting that, the way of storing to the cache database in the form of a key-value pair can refer to the relevant description in the embodiment shown in FIG. 2, which will not be described in detail here.

The method for determining a hybrid travel route provided by this embodiment includes: obtaining at least one position pair stored in a preset position pair list, where the position pair includes a starting point position and a terminal point position; determining a corresponding interchange point set according to each position pair; determining travel information of each road section constituting a corresponding hybrid travel route according to the each position pair and the corresponding interchange point set; and storing the travel information of each road section into cache database. Since a large amount of travel information of each road section is stored in the cache database through the second server in advance, after obtaining the hybrid travel route obtaining request of the user, the first server can obtain the travel information of each road section from the cache database one time and determine the optimal hybrid travel route according to travel information of each road section, thereby greatly improving the efficiency of determining the hybrid travel route.

### Embodiment 4

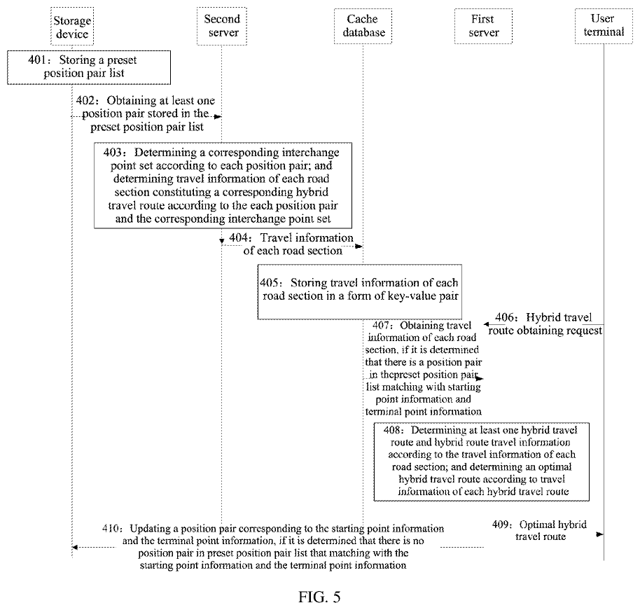

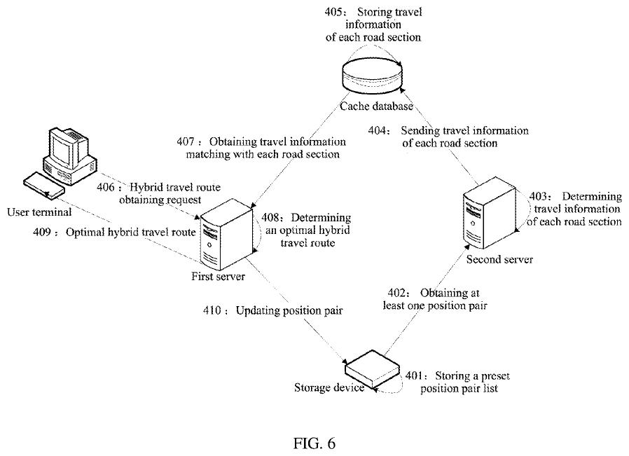

FIG. 5 is a signal flowchart of the method for determining a hybrid travel route provided in Embodiment 4 of the present disclosure; and FIG. 6 is a network architecture diagram of the method for determining a hybrid travel route provided in Embodiment 4 of the present disclosure. As shown in FIG. 5 and FIG. 6., the method for determining a hybrid travel route provided in the embodiment includes following steps:

Step 401, the storage device stores a preset position pair list.

Where the storage device can be independently provided in communicable devices of the first server and the second server, and it can communicate with the first server and the second server, respectively.

Step 402, the second server obtains at least one position pair stored in the preset position pair list, where the position pair includes the starting point position and the terminal point position.

Step 403, the second server determines a corresponding interchange point set according to each position pair; and determines travel information of each road section constituting a corresponding hybrid travel route according to the each position pair and the corresponding interchange point set.

Step 404, the second server sends the travel information of each road section to the cache database.

Step 405, the cache database stores travel information of each road section in a form of key-value pair.

Step 406, the user terminal sends a hybrid travel route obtaining request to the first server, where the obtaining request includes: starting point information and terminal point information.

Step 407, if the first server determines that there is a position pair in the preset position pair list matching with starting point information and terminal point information, the first server obtains travel information of each road section constituting at least one hybrid travel route matching with the starting point information and the terminal point information from the cache database.

Step 408, the first server determines at least one hybrid travel route and hybrid route travel information according to the travel information of each road section; and determines an optimal hybrid travel route according to travel information of each hybrid travel route.

Step 409, the first server sends the optimal hybrid travel route to the user terminal.

Step 410, if determining that there is no position pair in the preset position pair list matching with the starting point information and the terminal point information, the first server updates the position pair corresponding to the starting point information and the terminal point information to the preset position pair list of the storage device.

In this embodiment, the implementation of steps 401-410 is similar to the corresponding steps in the embodiments shown in FIG. 1-4, which will not be described in detail here.

### Embodiment 5

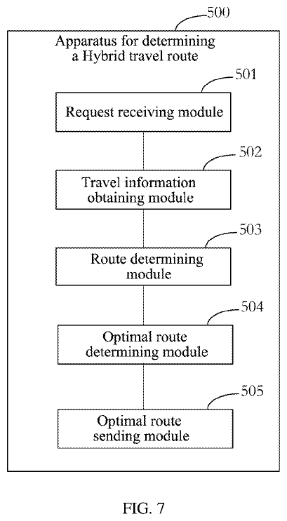

FIG. 7 is a structural diagram of an apparatus for determining a hybrid travel route provided in Embodiment 5 of the present disclosure, as shown in FIG. 7, the apparatus for determining a hybrid travel route provided in the embodiment is located in the first server, where the first server communicates with the cache database, and the cache database pre-stores the travel information of each road section constituting the hybrid travel route. The apparatus for determining a hybrid travel route 500 includes: a request receiving module 501, a travel information obtaining module 502, a route determining module 503, an optimal route determining module 504 and an optimal route sending module 505.

Where the request receiving module 501 is configured to receive a hybrid travel route obtaining request sent by the user terminal, and the obtaining request includes: starting point information and terminal point information. The travel information obtaining module 502 is configured to obtaining, from the cache database, travel information of each road section constituting at least one hybrid travel route matching with the starting point information and the terminal point information. The route determining module 503 is configured to determine at least one hybrid route and hybrid route travel information according to the travel information of each road section. The optimal route determining module 504 is configured to determine an optimal hybrid travel route according to travel information of each hybrid route. The optimal route sending module 505 is configured to send the optimal hybrid travel route to the user terminal.

The apparatus for determining a hybrid travel route provided in this embodiment can execute the technical solution of the method embodiment shown in FIG. 1, and its implementation principle and technical effect are similar to those of the method embodiment shown in FIG. 1, which will not be described in detail here.

Further, the apparatus for determining a hybrid travel route 500 provided in the embodiment also includes the following technical solution.

Further, the travel information obtaining module 502 is specifically configured to determine a starting point position in starting point information and terminal point position in terminal point information. And combine the starting point position and the terminal point position into a position pair. If it is determined that there is a position pair in the preset position pair list, travel information of each road section constituting at least one hybrid travel route that matches the position pair from the cache database is obtained. Where the travel information of each road section includes: starting point road section travel information, subway interchange section travel information and terminal point road section travel information.

Further, the route determining module 503 is specifically configured to splice each starting point road section, corresponding subway interchange road section, and corresponding terminal road section in sequence to form at least one hybrid travel route; determine, for each hybrid travel route, an optimal travel way of the starting point road section according to a walking distance in the starting point section travel information; determine an optimal travel way of the terminal point road section according to the walking distance in the terminal point road section travel information; and combine the starting point section travel information under the optimal travel way, the subway interchange road section travel information and the terminal point road section travel information under the optimal way, so as to form travel information of the hybrid travel route.

Further, the optimal route determining module 504 is specifically configured to determine a corresponding travel cost value according to travel information of the each hybrid travel route; and determine an optimal hybrid travel route from the hybrid travel route according to the travel cost value.

Further, the optimal route determining module 504, when determining a corresponding travel cost values according to travel information of each hybrid travel route, is specifically configured to determine corresponding multiple travel cost factor values according to the travel information of each hybrid travel route; weight sum of the multiple travel cost factor values to obtain a weighted summation result; and determine the weighted sum result as a corresponding travel cost value.

Where if the optimal travel ways of the starting point road section and the terminal point road section in the hybrid travel route are a taxi travel, the travel cost factor values include: a total travel time value, a total travel expense value, an interchange times value of subway interchange road section. If the optimal travel way of the starting point road section and/or the terminal point road section in the hybrid travel route is a walking, the travel cost factor values also include: a total walking distance value.

Further, the embodiment also includes: a travel information updating module, configured to store the position pair into the position pair list if the position pair does not exist in the preset position pair list, so as to determine, after a second server obtains the position pair, corresponding travel information of each road section according to the position pair and update it to the cache database.

The apparatus for determining a hybrid travel route provided in this embodiment can also execute the technical solution of the method embodiment shown in FIGS. 2-3 and FIG. 5. Its implementation principle and technical effect are similar to those of the method embodiment shown in FIGS. 2-3 and FIG. 5, which will not be described in detail here.

### Embodiment 6

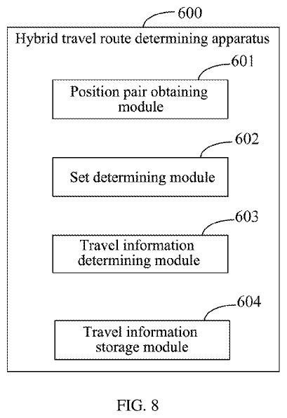

FIG. 8 is a structural diagram of an apparatus for determining a hybrid travel route provided in Embodiment 6 of the present disclosure, as shown in FIG. 8, the apparatus for determining a hybrid travel route provided in the embodiment is located in a second server, the second server communicates with a cache database to store travel information of each road section constituting a hybrid travel route into the cache database, and the apparatus for determining a hybrid travel route 600 includes: a position pair obtaining module 601, a set determining module 602, a travel information determining module 603, and a travel information storage module 604.

Where the position pair obtaining module 601 is configured to obtain at least one position pair stored in a preset position pair list, and the position pair includes a starting point position and a terminal point position. The set determining module 602 is configured to determine a corresponding interchange point set according to each position pair. The travel information determining module 603 is configured to determine travel information of each road section constituting a corresponding hybrid travel route according to the each position pair and the corresponding interchange point set. And the travel information storage module 604 is configured to store the travel information of each road section in the cache database.

Further, the apparatus for determining a hybrid travel route 600 provided in the embodiment also includes the following technical solutions.

Further, the set determining module 602 is specifically configured to determine a corresponding starting interchange point set according to a starting point position of each position pair; and determine a corresponding destination interchange point set according to a terminal position of each position pair.

Further, the set determining module 602, when determining a corresponding starting interchange point set according to the starting point position of each position pair, specifically, is configured to obtain at least one starting interchange point at a distance less than a preset threshold from the starting point position; and combining the at least one starting interchange point to form the starting interchange point set.

Further, the travel information determining module 603 is specifically configured to determine each starting point road section travel information according to the starting point position and each corresponding starting interchange point; determine each subway interchange road section travel information according to each starting interchange point and each destination interchange point; and determine each terminal road section travel information according to each destination interchange point and corresponding terminal position.

The apparatus for determining a hybrid travel route provided in this embodiment can execute the technical solution of the method embodiment shown in FIG. 4 and FIG. 5, and its implementation principle and technical effect are similar to those of the method embodiment shown in FIG. 4 and FIG. 5, which will not be described in detail here.

According to the method embodiment corresponding to the first server of the present disclosure, the present disclosure also provides a first server and a corresponding non-transitory computer-readable storage medium with computer instructions stored thereon.

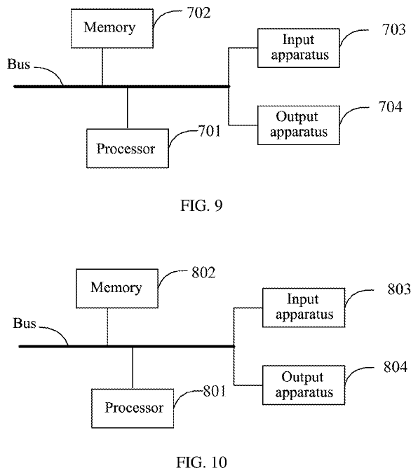

As shown in FIG. 9, it is a block diagram of a first server of the method for determining a hybrid travel route of the embodiments of the present disclosure. The first server can be a rack server, a blade server, a cloud server, a mainframe computer, and other suitable computers. The components, their connections and relationships, and their functions shown herein are merely examples and are not intended to limit the implementation of the present disclosure described and/or claimed herein.

As shown in FIG. 9, the first server includes: one or more processors 701, a memory 702, and interfaces for connecting various components which include a high-speed interface and a low-speed interface. Each component is connected to each other by different buses, and can be installed on a public motherboard or can be installed in other ways as needed. The processor can process instructions executed within the first server, which include instructions stored in memory or on memory to display graphical information of the GUI on an external input/output apparatus (e.g., a display device coupled to the interface). In other embodiments, multiple processors and/or multiple buses can be used together with multiple memories if needed. Similarly, multiple first servers can be connected, and each device provides some necessary operations (e.g., as a server array, a set of blade servers, or a multi-processor system). Taking one processor 701 as an example in FIG. 9.

The memory 702 is non-transitory computer readable storage medium provided by the present disclosure. Where the memory stores instructions that can be executed by at least one processor, so that at least one processor executes the method for determining a hybrid travel route provided in the present disclosure. The non-transitory computer-readable storage medium of the present disclosure stores computer instructions, and the computer instructions are configured to cause a computer to execute the method for determining a hybrid travel route provided by the present disclosure.

As a non-transitory computer readable storage medium, the memory 702 can be configured to store non-transitory software programs, non-transitory computer executable programs and modules, such as program instructions/modules corresponding to the method for determining a hybrid travel route in the embodiments of the present disclosure (e.g., the request receiving module 501, the travel information obtaining module 502, the route determining module 503, the optimal route determining module 504, and the optimal route sending module 505 shown in FIG. 7). The processor 701 runs non-transitory software programs, instructions, and modules stored in memory 702 to execute various functional applications and data processing of the server, that is, the method for determining a hybrid travel route in the above method embodiment is achieved.

The memory 702 can include a storage program region and a storage data region, where the storage program region can store an operating system and an application program needed by at least one function; and the storage data region can store data created according to the use of the first server of FIG. 9 and the like. In addition, the memory 702 can include a high-speed random access memory, and can also include a non-transitory memory, such as at least one magnetic disk storage device, a flash memory device, or other non-transitory solid-state storage device. In some embodiments, the memory 702 can optionally include memories set remotely with respect to the processor 701. These remote memories can be connected to the first server of FIG. 9 through a network. The examples of the above network include, but are not limited to, the Internet, an intranet, a local area network, a mobile communication network, and combinations thereof.

The first server of FIG. 9 can also include: an input apparatus 703 and am output apparatus 704. The processor 701, the memory 702, the input apparatus 703, and the output apparatus 704 can be connected by a bus or other means. In FIG. 9, a connection through a bus is used as an example.

The input apparatus 703 can receive input voice, number or character information, and generate key signal inputs related to user settings and function control of the first server of FIG. 9, such as a touch screen, a keypad, a mouse, a trackpad, a touchpad, an indicator bar, one or more mouse buttons, a trackball, a joystick and other input apparatus. The output apparatus 704 can include a voice playback device, a display device, an auxiliary lighting apparatus (e.g., a light emitting diode (LED)) and a haptic feedback apparatus (e.g., a vibration motor) and the like. The display device can include, but is not limited to, a liquid crystal display (LCD), a light emitting diode (LED) display and a plasma display. In some embodiments, the display device can be a touch screen.

Each embodiment of the systems and the technologies described herein can be implemented in a digital electronic circuit, an integrated circuit system, a dedicated ASIC (specific integrated circuit), computer hardware, firmware, software, and/or combinations thereof. These embodiments can include: the implementation is in one or more computer programs, the one or more computer programs can be executed and/or interpreted on a programmable system including at least one programmable processor which can be a dedicated or a general-purpose programmable processor. The programmable processor can be a dedicated or general-purpose programmable processor, which can receive data and instructions from a storage system, at least one input apparatus, and at least one output apparatus, and transmit data and instructions to the storage system, the at least one input apparatus, and the at least one output apparatus.

These computing programs (also called programs, software, software applications, or codes) include machine instructions of programmable processors, and these computing programs can be implemented using a high-level process and/or object-oriented programming languages, and/or assembly/machine languages. As used herein, the terms “machine-readable medium” and “computer-readable medium” refer to any computer program product, device, and/or apparatus used to provide machine instructions and/or data to the programmable processor (e.g., a magnetic disk, an optical disk, a memory, a programmable logic apparatus (PLD)), which includes a machine-readable medium receiving machine instructions as machine-readable signals. The term “machine-readable signal” refers to any signal used to provide machine instructions and/or data to the programmable processor.

In order to provide interaction with the user, the system and the technology described herein can be implemented on the computer, where the computer has: a display apparatus for displaying information to the user (e.g., a CRT (cathode ray tube) or a LCD (liquid crystal display) monitor); and a keyboard and a point apparatus (e.g., a mouse or a trackball), where the user can provide the input to the computer through a keyboard and a point apparatus. Other kinds of apparatus can also be configured to provide an interaction with the user; for example, the feedback provided to the user can be any form of sensory feedback (e.g., a visual feedback, an auditory feedback, or a tactile feedback); and can use any form (including an acoustic input, a voice input, or a tactile input) to receive the input from the user.

The systems and technologies described herein can be implemented in a computing system that includes back-destination components (e.g., as a data server), or a computing system that includes middleware components (e.g., application servers), or a computing system that includes front-destination components (e.g., a user computer with a graphical user interface or a web browser, through the graphical user interface or the web browser, a user can interact with an implementation of the systems and the technologies described herein), or a computing system including such background components, middleware components or any combination of front components. The components of the system can be interconnected through any form or medium of digital data communication (e.g., a communication network). Examples of the communication networks include: a local area network (LAN), a wide area network (WAN) and the Internet.

The computer system can include: a client and a server. The client and the server are generally far from each other and usually interact through the communication network. A relationship between the client and the server is generated by computer programs that run on corresponding computer and have a client-server relationship with each other.

According to the method embodiment corresponding to the second server of the present disclosure, the present disclosure also provides a second server and a corresponding non-transitory computer-readable storage medium with computer instructions stored thereon.

FIG. 10 is a block diagram of a second server of the method for determining a hybrid travel route of the embodiments of the present disclosure. The second server can be a rack server, a blade server, a cloud server, a mainframe computer, and other suitable computer. The components, their connections and relationships, and their functions shown herein are merely examples, and are not intended to limit the implementation of the present disclosure described and/or claimed herein.

As shown in FIG. 10, first server includes: one or more processors 801, a memory 802, and interfaces for connecting various components which include a high-speed interface and a low-speed interface. Each component is connected to each other by different buses, and can be installed on a public motherboard or can be installed in other ways as needed. The processor can process instructions executed within the second server, which include instructions stored in memory or on memory to display graphical information of the GUI on an external input/output apparatus, (e.g., a display device coupled to the interface). In other embodiments, multiple processors and/or multiple buses can be used together with multiple memories if needed. Similarly, multiple second servers can be connected, and each device provides some necessary operations (e.g., as a server array, a set of blade servers, or a multi-processor system).Taking one processor 801 as an example in FIG.10.

The Memory 802 is non-transitory computer readable storage medium provided by the present disclosure. Where the memory stores instructions that can be executed by at least one processor, so that at least one processor executes the method for determining a hybrid travel route provided in the present disclosure. The non-transitory computer-readable storage medium of the present disclosure stores computer instructions, and the computer instructions are configured to cause a computer to execute the method for determining a hybrid travel route provided by the present disclosure.

As a non-transitory computer readable storage medium, the memory 802 can be configured to store non-transitory software programs, non-transitory computer executable programs and modules, such as program instructions/modules corresponding to the method for determining a hybrid travel route in the embodiments of the present disclosure (e.g., the position pair obtaining module 601, the set determining module 602, travel information determining module 603, and travel information storage module 604 shown in FIG. 10). The processor 801 runs non-transitory software programs, instructions, and modules stored in the memory 802 to execute various functional applications and data processing of the server, that is, the method for determining a hybrid travel route in the above method embodiment is achieved.

The memory 802 may include a storage program region and a storage data region, where the storage program region can store an operating system and an application program needed by at least one function; and the storage data region can store data created according to the use of the second server of FIG. 10 and the like. In addition, the memory 802 can include a high-speed random access memory, and can also include a non-transitory memory, such as at least one magnetic disk storage device, a flash memory device, or other non-transitory solid-state storage device. In some embodiments, the memory 802 can optionally include memories set remotely with respect to the processor 801. These remote memories can be connected to the second server of FIG.10 through a network. The examples of the above network include, but are not limited to, the Internet, an intranet, a local area network, a mobile communication network, and combinations thereof.

The second server of FIG. 10 can also include: an input apparatus 803 and an output apparatus 804. The processor 801, the memory 802, the input apparatus 803, and the output apparatus 804 can be connected by a bus or other means. In FIG. 10, a connection through a bus is used as an example.

The input apparatus 803 can receive input voice, number or character information, and generate key signal inputs related to user settings and function control of the second server of FIG. 10, such as a touch screen, a keypad, a mouse, a trackpad, a touchpad, an indicator bar, one or more mouse buttons, a trackball, a joystick and other input apparatus. The output apparatus 804 can include a voice playback device, a display device, an auxiliary lighting apparatus (e.g., a LED) and a haptic feedback apparatus (e.g., a vibration motor) and the like. The display device can include, but is not limited to, a liquid crystal display (LCD), a light emitting diode (LED) display and a plasma display. In some embodiments, the display device can be a touch screen.

Each embodiment of systems and the technologies described herein can be implemented in a digital electronic circuit, an integrated circuit system, a dedicated ASIC (specific integrated circuit), computer hardware, firmware, software, and/or combinations thereof. These embodiments can include: the implementation is in one or more computer programs, the one or more computer programs can be executed and/or interpreted on a programmable system including at least one programmable processor which can be a dedicated or a general-purpose programmable processor The programmable processor can be a dedicated or general-purpose programmable processor, which can receive data and instructions from a storage system, at least one input apparatus, and at least one output apparatus, and transmit data and instructions to the storage system, the at least one input apparatus, and the at least one output apparatus.

These computing programs (also called programs, software, software applications, or codes) include machine instructions of programmable processors, and these computing programs can be implemented by using a high-level process and/or object-oriented programming languages, and/or assembly/machine languages. As used herein, the terms “machine-readable medium” and “computer-readable medium” refer to any computer program product, device, and/or apparatus used to provide machine instructions and/or data to the programmable processor (e.g., a magnetic disk, an optical disk, a memory, a programmable logic apparatus (PLD)), which includes a machine-readable medium receiving machine instructions as machine-readable signals. The term “machine-readable signal” refers to any signal used to provide machine instructions and/or data to the programmable processor.

In order to provide interaction with the user, the system and the technology described herein can be implemented on the computer, where the computer has: a display apparatus for displaying information to the user (e.g., a CRT (cathode ray tube) or a LCD (liquid crystal display) monitor); and a keyboard and a point apparatus (e.g., a mouse or a trackball), where the user can provide the input to the computer through a keyboard and a point apparatus. Other kinds of apparatus can also be configured to provide an interaction with the user; for example, the feedback provided to the user can be any form of sensory feedback (e.g., a visual feedback, an auditory feedback, or a tactile feedback); and can use any form (including an acoustic input, a voice input, or a tactile input) to receive the input from the user.

The systems and technologies described herein can be implemented in a computing system that includes back-destination components (e.g., as a data server), or a computing system that includes middleware components (e.g., application servers), or a computing system that includes front-destination components (e.g., a user computer with a graphical user interface or a web browser, through the graphical user interface or the web browser, a user can interact with an implementation of the systems and the technologies described herein), or a computing system including such background components, middleware components or any combination of front components. The components of the system can be interconnected through any form or medium of digital data communication (e.g., a communication network). Examples of the communication networks include: a local area network (LAN), a wide area network (WAN) and the Internet.

The computer system can include: a client and a server. The client and the server are generally far from each other and usually interact through the communication network. A relationship between the client and the server is generated by computer programs that run on corresponding computer and have a client-server relationship with each other.

According to technical solution of the embodiment of the present disclosure, since a large amount of travel information of each road section is pre-stored in the cache database. After the user has a request for obtaining a hybrid travel route, the travel information of each road section can be obtained from cache database at one time, and the optimal hybrid travel route can be determined according to travel information of each road section, thereby greatly improving the efficiency of determining the hybrid travel route

It should be understood that the various forms of processes shown above can be used to re-sequence, add, or delete steps. For example, Each steps recorded in the present disclosure can be executed in parallel, sequentially, or in different sequences, as long as the desired results of the technical solutions disclosed in the present disclosure can be achieved. There is no limitation herein.

The above specific implementations do not constitute a limitation on the protection scope of the present disclosure. It should be understood by those skilled in the art, according to design requirements and other factors, various modifications, combinations, sub-combinations, and substitutions can be made. Any modification, equivalent replacement and improvement made within the spirit and principle of the present disclosure shall be included in the protection scope of the present disclosure.

What is claimed is:

1. A method for determining a hybrid travel route, wherein the method is applied to a first server, the first server communicates with a cache database, the cache database pre-stores travel information of each road section constituting a hybrid travel route, and the method comprises:
receiving a hybrid travel route obtaining request sent by a user terminal, wherein the obtaining request comprises: starting point information and terminal point information;
obtaining, from the cache database, travel information of each road section constituting at least one hybrid travel route, which matches the starting point information and the terminal point information;
determining at least one hybrid travel route and hybrid route travel information according to the travel information of each road section;
determining an optimal hybrid travel route according to travel information of each hybrid travel route; and
sending the optimal hybrid travel route to the user terminal.

2. The method according to claim 1, wherein the obtaining, from the cache database, travel information of each road section constituting at least one hybrid travel route, which matches the starting point information and the terminal point information comprises:
determining a starting point position in the starting point information and a terminal point position in the terminal point information;
combining the starting point position and the terminal point position into a position pair; and
obtaining, from the cache database, travel information of each road section constituting at least one hybrid travel route that matches the position pair, if it is determined that position pair exists in the preset position pair list.

3. The method according to claim 1, wherein the travel information of each road section comprises: starting point road section travel information, subway interchange road section travel information and terminal road section travel information.

4. The method according to claim 3, wherein the determining at least one hybrid travel route and hybrid route travel information according to the travel information of each road section comprises:
splicing each starting point road section, corresponding subway interchange road section, and corresponding terminal road section in sequence to form at least one hybrid travel route; and
determining, for each hybrid travel route, an optimal travel way of the starting point road section according to a walking distance in the starting point road section travel information, determining an optimal travel way of the terminal point road section according to the walking distance in the terminal point road section travel information, combining the starting point road section travel information under the optimal travel way, the subway interchange road section travel information and the terminal road section travel information under the optimal travel way, so as to form travel information of the hybrid travel route.

5. The method according to claim 4, wherein the determining an optimal hybrid travel route according to travel information of each hybrid travel route comprises:
determining a corresponding travel cost value according to travel information of the each hybrid travel route; and
determining an optimal hybrid travel route from the hybrid travel route according to the travel cost value.

6. The method according to claim 5, wherein the determining a corresponding travel cost value according to travel information of the each hybrid travel route comprises:
determining corresponding multiple travel cost factor values according to the travel information of each hybrid travel route;
weighting sum of the multiple travel cost factor values to obtain a weighted sum result; and
determining the weighted sum result as a corresponding travel cost value.

7. The method according to claim 6, wherein
if the optimal travel ways of the starting point road section and the terminal point road section in the hybrid travel route are a taxi travel, the travel cost factor values comprise: a total travel time value, a total travel expense value, an interchange times value of subway interchange road section; and
if the optimal travel way of the starting point road section and/or the terminal point road section in the hybrid travel route is a walking travel, the travel cost factor values also comprise: a total walking distance value.

8. The method according to claim 2, further comprising:
storing the position pair into the position pair list if the position pair does not exist in the preset position pair list, so as to determine, after a second server obtains the position pair, corresponding travel information of each road section according to the position pair and update it to the cache database.

9. A method for determining a hybrid travel route, wherein the method is applied to a second server, the second server communicates with a cache database to store travel information of each road section constituting a hybrid travel route into the cache database, and the method comprises:
obtaining at least one position pair stored in a preset position pair list, wherein the position pair comprises a starting point position and a terminal point position;
determining a corresponding interchange point set according to each position pair;
determining travel information of each road section constituting a corresponding hybrid travel route according to the each position pair and the corresponding interchange point set; and
storing the travel information of each road section into the cache database.

10. The method according to claim 9, wherein the determining a corresponding interchange point set according to each position pair comprises:
determining a corresponding starting interchange point set according to a starting point position of each position pair; and
determining a corresponding destination interchange point set according to a terminal point position of each position pair.

11. The method according to claim 10, wherein the determining a corresponding starting interchange point set according to a starting point position of each position pair comprises:
obtaining at least one starting interchange point at a distance less than a preset threshold from the starting point position; and
combining the at least one starting interchange point to form the starting interchange point set.

12. The method according to claim 10, wherein the determining travel information of each road section constituting a corresponding hybrid travel route according to the each position pair and the corresponding interchange point set comprises:
determining each starting point road section travel information according to the starting point position and each corresponding starting interchange point;
determining each subway interchange road section travel information according to each starting interchange point and each destination interchange point; and
determining each terminal road section travel information according to each destination interchange point and corresponding destination position.

13. A first server, wherein the first server communicates with a cache database, the cache database pre-stores travel information of each road section constituting a hybrid travel route, and the first server comprises:
at least one processor;
an interface connected with the at least one processor; and
a memory connected with the at least one processor; wherein
the memory stores instructions that can be executed by the at least one processor, and the instructions, when executed by the at least one processor, cause the at least one processor to:
receive, through the interface, a hybrid travel route obtaining request sent by a user terminal, wherein the obtaining request comprises: starting point information and terminal point information;
obtain, from the cache database, the travel information of each road section constituting at least one hybrid travel route, which matches the starting point information and the terminal point information;
determine at least one hybrid route and hybrid route travel information according to the travel information of each road section;
determine an optimal hybrid travel route according to travel information of each hybrid travel route; and
send, through the interface, the optimal hybrid travel route to the user terminal.

14. A non-transitory computer-readable storage medium with computer instructions stored thereon, wherein the computer instructions are used to cause a computer to execute the method according to claim 1.

15. A non-transitory computer-readable storage medium with computer instructions stored thereon, wherein the computer instructions are used to cause a computer to execute the method according to claim 9.
